(19) United States
(12) Patent Application Publication
(10) Pub. No.: US 2005/0062400 A1
(43) Pub. Date: Mar. 24, 2005

(54) Electron emitter

(75) Inventors: Yukihisa Takeuchi, Nishikamo-gun (JP); Tsutomu Nanataki, Toyoake-city (JP); Iwao Ohwada, Nagoya-city (JP)

Correspondence Address: BURR & BROWN, PO BOX 7068, SYRACUSE, NY, 13261-7068, US

(73) Assignee: NGK Insulators, Ltd., Nagoya-City (JP)

(21) Appl. No.: 10/405,978

(22) Filed: Apr. 2, 2003

(30) Foreign Application Priority Data
Nov. 29, 2002 (JP) 2002-348908

(51) Int. Cl. H01J 1/62; H01J 63/04

(52) U.S. Cl. 313/495

(57) ABSTRACT

An electron emitter has an anode electrode formed on a substrate, an electric field receiving member formed on the substrate to cover the anode electrode, and a cathode electrode formed on the electric field receiving member. The cathode electrode is supplied with a drive signal from a pulse generation source, and the anode electrode is connected to an anode potential generation source (GND in this example). A collector electrode is provided above the cathode electrode, and the collector electrode is coated with a fluorescent layer. The collector electrode is connected to a collector potential generation source (Vc in this example) through a resistor.

### BACKGROUND OF THE INVENTION

1. Field of the Invention

The present invention relates to an electron emitter including a cathode electrode, an anode electrode and an electric field receiving member interposed between the cathode electrode and the anode electrode. The electric field receiving member is made of a dielectric material.

2. Description of the Related Art

In recent years, electron emitters having a cathode electrode and an anode electrode have been used in various applications such as field emission displays (FEDs) and backlight units. In an FED, a plurality of electron emitters are arranged in a two-dimensional array, and a plurality of fluorescent elements are positioned at predetermined intervals in association with the respective electron emitters.

Conventional electron emitters are disclosed in Japanese laid-open patent publication No. 1-311533, Japanese laid-open patent publication No. 7-147131, Japanese laid-open patent publication No. 2000-285801, Japanese patent publication No. 46-20944, and Japanese patent publication No. 44-26125, for example. All of these disclosed electron emitters are disadvantageous in that since no dielectric body is employed in the electric field receiving member, a forming process or a micromachining process is required between facing electrodes, a high voltage needs to be applied between the electrodes to emit electrons, and a panel fabrication process is complex and entails a high panel fabrication cost.

It has been considered to make an electric field receiving member of a dielectric material. Various theories about the emission of electrons from a dielectric material have been presented in the documents: Yasuoka and Ishii, “Pulsed electron source using a ferroelectric cathode”, J. Appl. Phys., Vol. 68, No. 5, p. 546-550 (1999), V. F. Puchkarev, G. A. Mesyats, “On the mechanism of emission from the ferroelectric ceramic cathode”, J. Appl. Phys., Vol. 78, No. 9, 1 November, 1995, p. 5633-5637, and H. Riege, “Electron emission ferroelectrics—a review”, Nucl. Instr. and Meth. A340, p. 80-89 (1994). However, the principles behind an emission of electrons have not yet been established, and advantages of an electron emitter having an electric field receiving member made of a dielectric material have not been achieved.

### SUMMARY OF THE INVENTION

It is an object of the present invention to provide an electron emitter having an electric field receiving member made of a dielectric material in which excessive emission of electrons is suppressed for preventing damages of a cathode electrode or the like due to the emission of electrons, so that the electron emitter has a long service life and high reliability.

According to the present invention, an electron emitter comprises an anode electrode formed on a substrate, an electric field receiving member formed on the substrate to cover the anode electrode, and a cathode electrode formed on the electric field receiving member. The electric field receiving member is made of a dielectric material. The cathode electrode is supplied with a drive signal.

In the electron emitter, the electric field receiving member may be made of a piezoelectric material, an anti-ferroelectric material, or an electrostrictive material. A collector electrode may be provided above the cathode electrode, and the collector electrode may be coated with a fluorescent layer.

Polarization reversal may occur in an electric field E represented by E=V/d, where d is a thickness of the electric field receiving member between the cathode electrode and the anode electrode, and V is a voltage applied between the cathode electrode and the anode electrode. The thickness d may be determined so that the voltage V applied between the cathode electrode and the anode electrode has an absolute value of less than 100V.

Operation of the invention is described. Firstly, a drive signal for reversing the positive polarity into negative polarity (negative signal for reversing polarization of the electric field receiving member made of a dielectric material) is supplied to the cathode electrode. Thus, electrons are emitted from electric field concentration points (triple points of the cathode electrode, the electric field receiving member, and the vacuum) on the side of the cathode electrode. Specifically, in the electric field receiving member, dipole moments near the cathode electrode are charged when the polarization of the electric field receiving member has been reversed. Thus, emission of the electrons occurs.

A local cathode is formed in the cathode electrode in the vicinity of the interface between the cathode electrode and the electric field receiving member, and positive poles of the dipole moments charged in the area of the electric field receiving member near the cathode electrode serve as a local anode which causes the emission of electrons from the cathode electrode. Some of the emitted electrons are guided to the collector electrode to excite the fluorescent layer to emit fluorescent light from the fluorescent layer to the outside. Further, some of the emitted electrons impinge upon the electric field receiving member to cause the electric field receiving member to emit secondary electrons. The secondary electrons are guided to the collector electrode to excite the fluorescent layer.

As the electron emission from the cathode electrode progresses, floating atoms of the electric field receiving member which are evaporated due to the Joule heat are ionized into positive ions and electrons by the emitted electrons. The electrons generated by the ionization ionize the atoms of the electric field receiving member. Therefore, the electrons are increased exponentially to generate a local plasma in which the electrons and the positive ions are neutrally present. The positive ions generated by the ionization may impinge upon the cathode electrode, for example, possibly damaging the cathode electrode.

In the present invention, the electrons emitted from the cathode electrode are attracted to the positive poles, which are present as the local anode, of the dipole elements in the electric field receiving member, negatively charging the surface of the electric field receiving member near the cathode electrode. As a result, the factor for accelerating the electrons (the local potential difference) is lessened, and any potential for emitting secondary electrons is eliminated, further progressively negatively charging the surface of the electric field receiving member.

Therefore, the positive polarity of the local anode provided by the dipole moments is weakened, and the intensity of the electric field between the local anode and the local cathode is reduced. Thus, the electron emission is stopped.

As described above, in the present invention, excessive emission of electrons is suppressed for preventing damages of the cathode electrode or the like due to the emission of electrons, so that the electron emitter has a long service life and high reliability.

In the present invention, preferably, the cathode electrode is made of a conductor having a high evaporation temperature in vacuum. Thus, the electric field receiving member is not evaporated into floating atoms easily due to the Joule heat, and the ionization by the emitted electrons is prevented. Therefore, the surface of the electric field receiving member is effectively protected.

The cathode electrode may have a ring shape or a comb teeth shape to increase the number of electric field concentration points, i.e., triple points of the cathode electrode, the electric field receiving member, and the vacuum. Thus, efficiency of electron emission is improved.

The cathode electrode may have a thickness of 100 nm or less. In particular, if the cathode electrode is very thin, having a thickness of 10 nm or less, electrons are emitted from the interface between the cathode electrode and the electric field receiving member, and thus, the efficiency of the electron emission is further improved.

A protective film may be formed on the electric field receiving member to cover the cathode electrode. The protective film protects the surface of the electric field receiving member. Further, even if ionization occurs due to the electron emission, the protective film reduces the damages of the cathode electrode by the positive ions.

Preferably, the protective film has a thickness in the range of 1 nm to 20 nm. If the protective film is too thin, the protective film can not sufficiently protect the electric field receiving member. If the protective film is too thick, the protective film has a small electric resistance, and the voltage between the local cathode and the local anode is small. Therefore, sufficient electric field for emitting electrons may not be generated. Further, if the protective film is too thick, the cathode electrode can not emit electrons.

The protective film may be made of a conductor. Preferably, the conductor has a sputtering yield of 2.0 or less at 600V in Ar⁺. Preferably, the conductor has an evaporation pressure of 1.3×10⁻³ Pa at a temperature of 1800 K or higher in vacuum. Thus, the protective film is not broken easily, and the protect cover is not evaporated into atoms due to the Joule heat.

The protective film may be an insulator film, or a metal oxide film. Alternatively, the protective film may be made of ceramics, a piezoelectric material, or an electrostrictive material. When the electrons emitted from the cathode electrode is attracted to the local anode of the electric field receiving member, the surface of the protective film is charged negatively. Therefore, the positive polarity of the local anode is weakened, the electric field between the local anode and the local cathode is weakened, and the intensity of the electric field between the local anode and the local cathode is reduced. Thus, the electron emission is stopped.

In the present invention, preferably, the change of the voltage between the cathode electrode and the anode electrode at the time of electron emission is 20V or less.

The above and other objects, features, and advantages of the present invention will become more apparent from the following description of preferred embodiments when taken in conjunction with the accompanying drawings.

### BRIEF DESCRIPTION OF THE DRAWINGS

FIG. 1 is a view showing an electron emitter according to a first embodiment;

FIG. 2 is a plan view showing electrodes of the electron emitter according to the first embodiment;

FIG. 3 is a plan view showing electrodes in a first modification of the electron emitter according to the first embodiment;

FIG. 4 is a plan view showing electrodes in a second modification of the electron emitter according to the first embodiment;

FIG. 5 is a plan view showing electrodes in a third modification of the electron emitter according to the first embodiment;

FIG. 6 is a waveform diagram showing a drive signal outputted from a pulse generation source;

FIG. 7 is a view illustrative of operation when a positive voltage is applied to a cathode electrode;

FIG. 8 is a view illustrative of operation of electron emission when a negative voltage is applied to the cathode electrode;

FIG. 9 is a view showing operation of self-stop of electron emission when the electric field receiving member is charged negatively;

FIG. 10A is a waveform diagram showing an example of a drive signal;

FIG. 10B is a waveform diagram showing the change of the voltage applied between an anode electrode and the cathode electrode of the electron emitter according to the first embodiment;

FIG. 11 is a view showing an electron emitter according to a second embodiment;

FIG. 12 is a view showing operation in a first modification of the electron emitter according to the second embodiment; and

FIG. 13 is a view showing operation in a second modification of the electron emitter according to the second embodiment.

### DESCRIPTION OF THE PREFERRED EMBODIMENTS

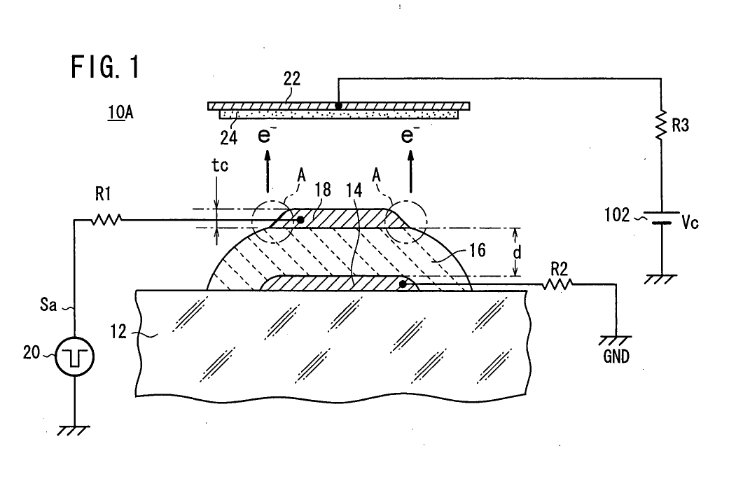

Electron emitters according to embodiments of the present invention will be described below with reference to FIGS. 1 through 13.

Generally, the electron emitters can be used in displays, electron beam irradiation apparatus, light sources, alternatives to LEDs, and apparatus for manufacturing electronic parts.

Electron beams in electron beam irradiation apparatus have a high energy and a good absorption capability in comparison with ultraviolet rays in ultraviolet ray irradiation apparatus that are presently in widespread use. Electron emitters are used to solidify insulating films in superposing wafers for semiconductor devices, harden printing inks without irregularities for drying prints, and sterilize medical devices while being kept in packages.

The electron emitters are also used as high-luminance, high-efficiency light sources for use in projectors, for example.

The electron emitters are also used as alternatives to LEDs in chip light sources, traffic signal devices, and backlight units for small-size liquid-crystal display devices for cellular phones.

The electron emitters are also used in apparatus for manufacturing electronic parts, including electron beam sources for film growing apparatus such as electron beam evaporation apparatus, electron sources for generating a plasma (to activate a gas or the like) in plasma CVD apparatus, and electron sources for decomposing gases.

The electron emitters are also used as vacuum micro devices such as ultra-high speed devices operated at a frequency on the order of Tera-Hz, and environment adaptive electronic parts used in a wide temperature range.

The electron emitters are also used as electronic circuit devices including digital devices such as switches, relays, and diodes, and analog devices such as operational amplifiers. The electron emitters are used for realizing a large current output, and a high amplification ratio.

As shown in FIG. 1, an electron emitter 10A according to a first embodiment has an anode electrode 14 formed on a substrate 12, and an electric field receiving member 16 formed on the substrate 12 to cover the anode electrode 14, and a cathode electrode 18 formed on the electric field receiving member 16.

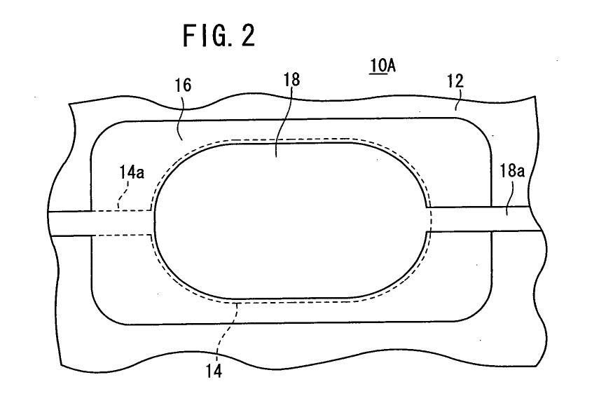

The cathode electrode 18 is supplied with a drive signal Sa from a pulse generation source 20 through a resistor R1, and the anode electrode 14 is connected to an anode potential generation source (GND in this example) through a resistor R2. As shown in FIG. 2, for example, the drive signal Sa is supplied to the cathode electrode 18 through a lead electrode 18a extending from the cathode electrode 18. The anode potential (Vss) is applied to the anode electrode 14 through a lead electrode 14a extending from the anode electrode 14.

For using the electron emitter 10A as a pixel of a display, a collector electrode 22 is positioned above the cathode electrode 18, and the collector electrode 22 is coated with a fluorescent layer 24. The collector electrode 22 is connected to a collector potential generation source 102 (Vc in this example) through a resistor R3.

The electron emitter 10A according to the first embodiment is placed in a vacuum space. As shown in FIG. 1, the electron emitter 10A has electric field concentration points A. The point A can be defined as a triple point where the cathode electrode 18, the electric field receiving member 16, and the vacuum are present at one point.

The vacuum level in the atmosphere is preferably in the range from 10² to 10⁻⁶ Pa and more preferably in the range from 10⁻³ to 10⁻⁵ Pa.

The range of the vacuum level is determined for the following reason. In a lower vacuum, many gas molecules would be present in the space, and (1) a plasma can easily be generated and, if the plasma were generated excessively, many positive ions would impinge upon the cathode electrode and damage the cathode electrode, and (2) emitted electrons would impinge upon gas molecules prior to arrival at the collector electrode, failing to sufficiently excite the fluorescent layer with electrons that are sufficiently accelerated by the collector potential (Vss).

In a higher vacuum, though electrons are smoothly emitted from the electric field concentration points A, (1) gas molecules would be insufficient to generate a plasma, and (2) structural body supports and vacuum seals would be large in size, posing difficulty in making a small electron emitter.

The electric field receiving member 16 is made of a dielectric material. The dielectric material should preferably have a high relative dielectric constant (relative permittivity), e.g., a dielectric constant of 1000 or higher. Dielectric materials of such a nature may be ceramics including barium titanate, lead zirconate, lead magnesium niobate, lead nickel niobate, lead zinc niobate, lead manganese niobate, lead magnesium tantalate, lead nickel tantalate, lead antimony stannate, lead titanate, barium titanate, lead magnesium tungstenate, lead cobalt niobate, etc. or a material whose principal component contains 50 weight % or more of the above compounds, or such ceramics to which there is added an oxide of lanthanum, calcium, strontium, molybdenum, tungsten, barium, niobium, zinc, nickel, manganese, or the like, or a combination of these materials, or any of other compounds.

For example, a two-component material nPMN-mPT (n, m represent molar ratios) of lead magnesium niobate (PMN) and lead titanate (PT) has its Curie point lowered for a larger relative dielectric constant at room temperature if the molar ratio of PMN is increased.

Particularly, a dielectric material where n=0.85-1.0 and m=1.0−n is preferable because its relative dielectric constant is 3000 or higher. For example, a dielectric material where n=0.91 and m=0.09 has a relative dielectric constant of 15000 at room temperature, and a dielectric material where n=0.95 and m=0.05 has a relative dielectric constant of 20000 at room temperature.

For increasing the relative dielectric constant of a three-component dielectric material of lead magnesium niobate (PMN), lead titanate (PT), and lead zirconate (PZ), it is preferable to achieve a composition close to a morphotropic phase boundary (MPB) between a tetragonal system and a quasi-cubic system or a tetragonal system and a rhombohedral system, as well as to increase the molar ratio of PMN. For example, a dielectric material where PMN:PT PZ=0.375:0.375:0.25 has a relative dielectric constant of 5500, and a dielectric material where PMN:PT:PZ=0.5:0.375:0.125 has a relative dielectric constant of 4500, which is particularly preferable. Furthermore, it is preferable to increase the dielectric constant by introducing a metal such as platinum into these dielectric materials within a range to keep them insulative. For example, a dielectric material may be mixed with 20 weight % of platinum.

As described above, the electric field receiving member 16 may be formed of a piezoelectric/electrostrictive layer or an anti-ferroelectric layer. If the electric field receiving member 16 is a piezoelectric/electrostrictive layer, then it may be made of ceramics such as lead zirconate, lead magnesium niobate, lead nickel niobate, lead zinc niobate, lead manganese niobate, lead magnesium tantalate, lead nickel tantalate, lead antimony stannate, lead titanate, barium titanate, lead magnesium tungstenate, lead cobalt niobate, or the like. or a combination of any of these materials.

The electric field receiving member 14 may be made of chief components including 50 weight % or more of any of the above compounds. Of the above ceramics, the ceramics including lead zirconate is most frequently used as a constituent of the piezoelectric/electrostrictive layer of the electric field receiving member 16.

If the piezoelectric/electrostrictive layer is made of ceramics, then lanthanum, calcium, strontium, molybdenum, tungsten, barium, niobium, zinc, nickel, manganese, or the like, or a combination of these materials, or any of other compounds may be added to the ceramics.

For example, the piezoelectric/electrostrictive layer should preferably be made of ceramics including as chief components lead magnesium niobate, lead zirconate, and lead titanate, and also including lanthanum and strontium.

The piezoelectric/electrostrictive layer may be dense or porous. If the piezoelectric/electrostrictive layer is porous, then it should preferably have a porosity of 40% or less.

If the electric field receiving member 16 is formed of an anti-ferroelectric layer, then the anti-ferroelectric layer may be made of lead zirconate as a chief component, lead zirconate and lead stannate as chief components, lead zirconate with lanthanum oxide added thereto, or lead zirconate and lead stannate as components with lead zirconate and lead niobate added thereto.

The anti-ferroelectric layer may be porous. If the anti-ferroelectric layer is porous, then it should preferably have a porosity of 30% or less.

The electric field receiving member 16 may be formed on the substrate 12 by any of various thick-film forming processes including screen printing, dipping, coating, electrophoresis, etc., or any of various thin-film forming processes including an ion beam process, sputtering, vacuum evaporation, ion plating, chemical vapor deposition (CVD), plating, etc.

In the first embodiment, the electric field receiving member 16 is formed on the substrate 12 suitably by any of various thick-film forming processes including screen printing, dipping, coating, electrophoresis, etc.

These thick-film forming processes are capable of providing good piezoelectric operating characteristics as the electric field receiving member 16 can be formed using a paste, a slurry, a suspension, an emulsion, a sol, or the like which is chiefly made of piezoelectric ceramic particles having an average particle diameter ranging from 0.01 to 5 μm, preferably from 0.05 to 3 μm.

In particular, electrophoresis is capable of forming a film at a high density with high shape accuracy, and has features described in technical documents such as “Electrochemistry Vol. 53. No. 1 (1985), p. 63-68, written by Kazuo Anzai”, and “The 1^{st} Meeting on Finely Controlled Forming of Ceramics Using Electrophoretic Deposition Method, Proceedings (1998), p. 5-6, p. 23-24”. Any of the above processes may be chosen in view of the required accuracy and reliability.

The thickness d (see FIG. 1) of the electric field receiving member 16 between the cathode electrode 18 and the anode electrode 14 is determined so that polarization reversal occurs in the electric field E represented by E=V/d (V is a voltage applied between the electrodes 16 and 20). When the thickness d is small, the polarization reversal occurs at a low voltage, and electrons are emitted at the low voltage-(e.g., less than 100V).

The cathode electrode 18 is made of materials described below. The cathode electrode 18 should preferably be made of a conductor having a small sputtering yield and a high evaporation temperature in vacuum. For example, materials having a sputtering yield of 2.0 or less at 600 V in Ar⁺ and an evaporation pressure of 1.3×10⁻³ Pa at a temperature of 1800 K or higher are preferable. Such materials include platinum, molybdenum, tungsten, etc. Further, the cathode electrode 18 is made of a conductor which is resistant to a high-temperature oxidizing atmosphere, e.g., a metal, an alloy, a mixture of insulative ceramics and a metal, or a mixture of insulative ceramics and an alloy. Preferably, the cathode electrode 18 should be composed chiefly of a precious metal having a high melting point, e.g., platinum, palladium, rhodium, molybdenum, or the like, or an alloy of silver and palladium, silver and platinum, platinum and palladium, or the like, or a cermet of platinum and ceramics. Further preferably, the cathode electrode 18 should be made of platinum only or a material composed chiefly of a platinum-base alloy. The electrode should preferably be made of carbon or a graphite-base material, e.g., diamond thin film, diamond-like carbon, or carbon nanotube. Ceramics to be added to the electrode material should preferably have a proportion ranging from 5 to 30 volume %.

The cathode electrode 18 may be made of any of the above materials by an ordinary film forming process which may be any of various thick-film forming processes including screen printing, spray coating, dipping, coating, electrophoresis, etc., or any of various thin-film forming processes including sputtering, an ion beam process, vacuum evaporation, ion plating, CVD, plating, etc. Preferably, the cathode electrode 18 is made by any of the above thick-film forming processes.

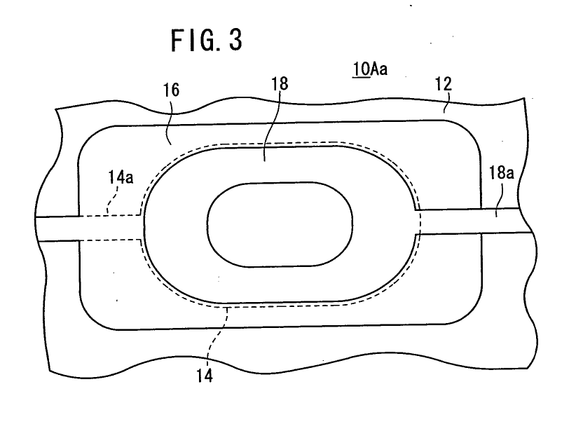

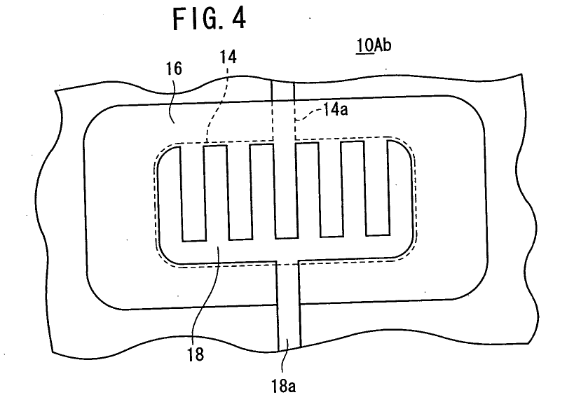

The cathode electrode 18 may have an oval shape as shown in a plan view of FIG. 2, or a ring shape like an electron emitter 10Aa of a first modification as shown in a plan view of FIG. 3. Alternatively, the cathode electrode 18 may have a comb teeth shape like an electron emitter 10Ab of a second modification as shown in FIG. 4.

When the cathode electrode 18 having a ring shape or a comb teeth shape in a plan view is used, the number of triple points (electric field concentration points A) of the cathode electrode 18, the electric field receiving member 16, and the vacuum is increased, and the efficiency of electron emission is improved.

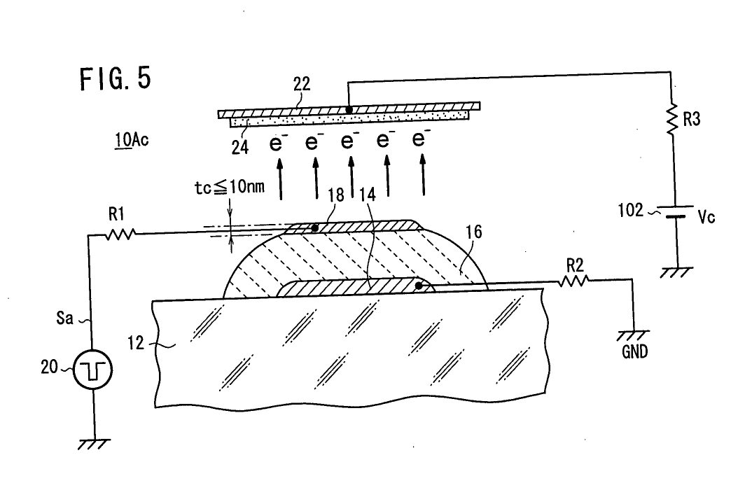

Preferably, the cathode electrode 18 has a thickness tc (see FIG. 1) of 20 μm or less, or more preferably 5 μm or less. The cathode electrode 18 may have a thickness tc of 100 nm or less. In particular, an electron emitter 10Ac of a third modification shown in FIG. 5 is very thin, having a thickness tc of 10 nm or less. In this case, electrons are emitted from the interface between the cathode electrode 18 and the electric field receiving member 16, and thus, the efficiency of electron emission is further improved.

The anode electrode 14 is made of the same material by the same process as the cathode electrode 18. Preferably, the anode electrode 14 is made by any of the above thick-film forming processes. Preferably, the anode electrode 14 has a thickness tc of 20 μm or less, or more preferably 5 μm or less.

The substrate 12 should preferably be made of an electrically insulative material in order to electrically isolate the lead electrode 18a electrically connected to the cathode electrode 18 and the lead electrode 14a electrically connected to the anode electrode 14 from each other.

Thus, the substrate 12 may be made of a highly heat-resistant metal or a metal material such as an enameled metal whose surface is coated with a ceramic material such as glass or the like. However, the substrate 12 should preferably be made of ceramics.

Ceramics which the substrate 12 is made of include stabilized zirconium oxide, aluminum oxide, magnesium oxide, titanium oxide, spinel, mullite, aluminum nitride, silicon nitride, glass, or a mixture thereof. Of these ceramics, aluminum oxide or stabilized zirconium oxide is preferable from the standpoint of strength and rigidity. Stabilized zirconium oxide is particularly preferable because its mechanical strength is relatively high, its tenacity is relatively high, and its chemical reaction with the cathode electrode 18 and the anode electrode 14 is relatively small. Stabilized zirconium oxide includes stabilized zirconium oxide and partially stabilized zirconium oxide. Stabilized zirconium oxide does not develop a phase transition as it has a crystalline structure such as a cubic system.

Zirconium oxide develops a phase transition between a monoclinic system and a tetragonal system at about 1000° C. and is liable to suffer cracking upon such a phase transition. Stabilized zirconium oxide contains 1 to 30 mol % of a stabilizer such as calcium oxide, magnesium oxide, yttrium oxide, scandium oxide, ytterbium oxide, cerium oxide, or an oxide of a rare earth metal. For increasing the mechanical strength of the substrate 12, the stabilizer should preferably contain yttrium oxide. The stabilizer should preferably contain 1.5 to 6 mol % of yttrium oxide, or more preferably 2 to 4 mol % of yttrium oxide, and furthermore should preferably contain 0.1 to 5 mol % of aluminum oxide.

The crystalline phase may be a mixed phase of a cubic system and a monoclinic system, a mixed phase of a tetragonal system and a monoclinic system, a mixed phase of a cubic system, a tetragonal system, and a monoclinic system, or the like. The main crystalline phase which is a tetragonal system or a mixed phase of a tetragonal system and a cubic system is optimum from the standpoints of strength, tenacity, and durability.

If the substrate 12 is made of ceramics, then the substrate 12 is made up of a relatively large number of crystalline particles. For increasing the mechanical strength of the substrate 12, the crystalline particles should preferably have an average particle diameter ranging from 0.05 to 2 μm, or more preferably from 0.1 to 1 μm.

Each time the electric field receiving member 16, the cathode electrode 18, or the anode electrode 14 is formed, the assembly is heated (sintered) into a structure integral with the substrate 12. After the electric field receiving member 16, the cathode electrode 18, and the anode electrode 14, are formed, they may simultaneously be sintered so that they may simultaneously be integrally coupled to the substrate 12. Depending on the process by which the cathode electrode 18 and the anode electrode 14 are formed, they may not be heated (sintered) so as to be integrally combined with the substrate 12.

The sintering process for integrally combining the substrate 12, the electric field receiving member 16, the cathode electrode 18, and the anode electrode 14 may be carried out at a temperature ranging from 500 to 1400° C., preferably from 1000 to 1400° C. For heating the electric field receiving member 16 which is in the form of a film, the electric field receiving member 16 should be sintered together with its evaporation source while their atmosphere is being controlled.

The electric field receiving member 16 may be covered with an appropriate member for preventing the surface thereof from being directly exposed to the sintering atmosphere when the electric field receiving member 16 is sintered. The covering member should preferably be made of the same material as the substrate 12.

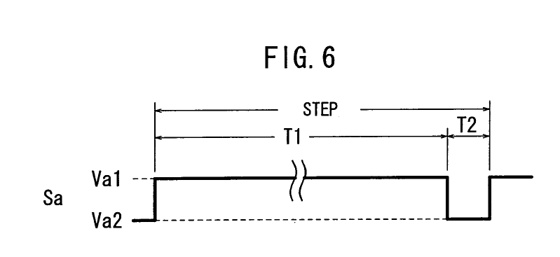

The principles of electron emission of the electron emitter 10A will be described below with reference to FIGS. 1, 6 through 10B. As shown in FIG. 6, the drive signal Sa outputted from the pulse generation source 20 has repeated steps each including a period in which a positive voltage Va1 is outputted (preparatory period T1) and a period in which a negative voltage Va2 is outputted (electron emission period T2).

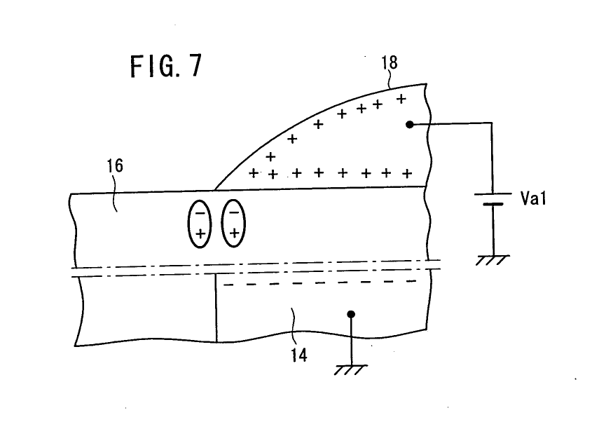

The preparatory period T1 is a period in which the positive voltage Va1 is applied to the cathode electrode 18 to polarize the electric field receiving member 16, as shown in FIG. 7. The positive voltage Va1 may be a DC voltage, as shown in FIG. 6, but may be a single pulse voltage or a succession of pulse voltages. In the preparatory period T1, the electric field receiving member 16 is polarized by the positive voltage Va1 which is smaller than the absolute value of the negative voltage Va2 for electron emission in order to prevent the power consumption from being unduly increased when the positive voltage Va1 is applied. Therefore, the preparatory period T1 should preferably be longer than the electron emission period T2 for sufficient polarization. For example, the preparatory period T1 should preferably be in the range from 100 to 150 psec.

The voltage levels of the positive voltage Va1 and the negative voltage Va2 are determined so that the polarization to the positive polarity and the negative polarity can be performed reliably. For example, if the dielectric material of the electric field receiving member 16 has a coercive voltage, preferably, the absolute values of the positive voltage Va1 and the negative voltage Va2 are the coercive voltage or higher.

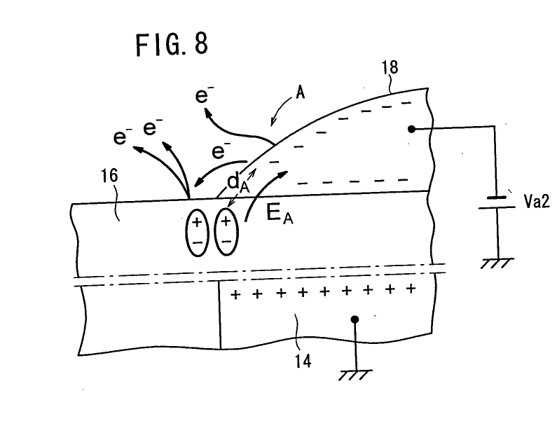

The electron emission period T2 is a period in which the negative voltage Va2 is applied to the cathode electrode 18. When the negative voltage Va2 is applied to the cathode electrode 18, as shown in FIG. 8, the polarization of the electric field receiving member 16 is reversed, causing electrons to be emitted from the electric field concentration point A. If the cathode electrode 18 is very thin, having a thickness tc of 10 nm or less, electrons are emitted from the interface between the cathode electrode 18 and the electric field receiving member 16.

Specifically, dipole moments are charged in the interface between the electric field receiving member 16 whose polarization has been reversed and the cathode electrode 18 to which the negative voltage Va2 is applied. Electrons are emitted when the direction of these dipole moments is changed. The electrons are considered to include primary electrons emitted from the cathode electrode 18 and secondary electrons emitted from the electric field receiving member 16 upon collision of the primary electrons with the electric field receiving member 16, in a local concentrated electric field developed between the cathode electrode 18 and the positive poles of the dipole moments near the cathode electrode 18. The electron emission period T2 should preferably be in the range from 5 to 10 psec.

Operation by application of the negative voltage Va2 will be described in detail below.

When the negative voltage Va2 is applied to the cathode electrode 18, electrons are emitted from the point A or the interface between the cathode electrode 18 and the electric field receiving member 16. Specifically, in the electric field receiving member 16, dipole moments near the cathode electrode 18 are charged when the polarization of the electric field receiving member has been reversed. Thus, emission of the electrons occurs.

A local cathode is formed in the cathode electrode 18 in the vicinity of the interface between the cathode electrode 18 and the electric field receiving member 16, and positive poles of the dipole moments charged in the area of the electric field receiving member 16 near the cathode electrode 18 serve as a local anode which causes the emission of electrons from the cathode electrode 18. Some of the emitted electrons are guided to the collector electrode 22 (see FIG. 1) to excite the fluorescent layer 24 to emit fluorescent light from the fluorescent layer 24 to the outside. Further, some of the emitted electrons impinge upon the electric field receiving member 16 to cause the electric field receiving member 16 to emit secondary electrons. The secondary electrons are guided to the collector electrode 22 to excite the fluorescent layer 24.

The intensity E_{A} of the electric field at the electric field concentration point A satisfies the equation E_{A}=Vak/d_{A} where Vak represents the voltage applied between the cathode electrode 18 and the anode electrode 14 and d_{A} represents the distance between the local anode and the local cathode. Because the distance d_{A} between the local anode and the local cathode is very small, it is possible to easily obtain the intensity E_{A} of the electric field which is required to emit electrons (the large intensity E_{A} of the electric field is indicated by the solid-line arrow in FIG. 8). This ability to easily obtain the intensity E_{A} of the electric field leads to a reduction in the voltage Vak.

As the electron emission from the cathode electrode 18 progresses, floating atoms of the electric field receiving member 16 which are evaporated due to the Joule heat are ionized into positive ions and electrons by the emitted electrons. The electrons generated by the ionization ionize the atoms of the electric field receiving member 16. Therefore, the electrons are increased exponentially to generate a local plasma in which the electrons and the positive ions are neutrally present. The positive ions generated by the ionization may impinge upon the cathode electrode 18, possibly damaging the cathode electrode 18.

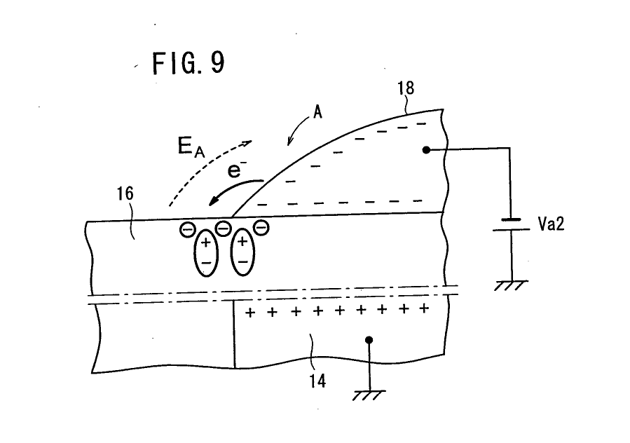

In the electron emitter 10A according to the first embodiment, as shown in FIG. 9, the electrons emitted from the cathode electrode 18 are attracted to the positive poles, which are present as the local anode, of the dipole elements in the electric field receiving member 16, negatively charging the surface of the electric field receiving member 16 near the cathode electrode 18. As a result, the factor for accelerating the electrons (the local potential difference) is lessened, and any potential for emitting secondary electrons is eliminated, further progressively negatively charging the surface of the electric field receiving member 16.

Therefore, the positive polarity of the local anode provided by the dipole moments is weakened, and the intensity E_{A} of the electric field between the local anode and the local cathode is reduced (the small intensity E_{A} of the electric field is indicated by the broken-line arrow in FIG. 9). Thus, the electron emission is stopped.

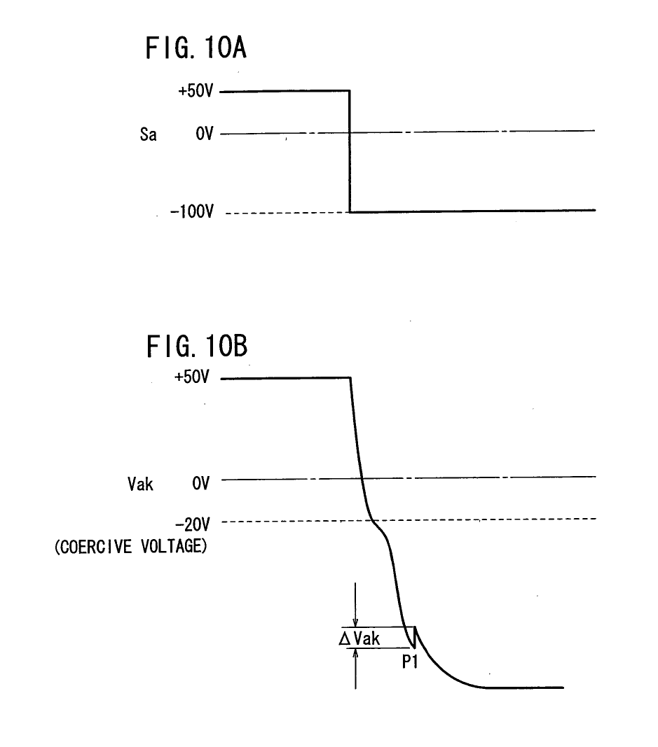

As shown in FIG. 10A, the drive signal Sa supplied to the cathode electrode 18 has a positive voltage Va1 of 50 V, and a negative voltage va2 of −100V. The change ΔVak of the voltage between the cathode electrode 18 and the anode electrode 14 at the time P1 (peak) the electrons are emitted is 20V or less (about 10 V in the example of FIG. 10B), and very small. Consequently, almost no positive ions are generated, thus preventing the cathode electrode 18 from being damaged by positive ions. This arrangement is thus effective to increase the service life of the electron emitter 10A.

The electric field receiving member 16 is likely to be damaged when electrons emitted from the cathode electrode 18 impinge upon the electric field receiving member 16 or when ionization occurs near the surface of the electric field receiving member 16. Due to the damages to the crystallization, the mechanical strength and the durability of the electric field receiving member 16 are likely to be lowered.

In order to avoid the problem, preferably, the electric field receiving member 16 is made of a dielectric material having a high evaporation temperature in vacuum. For example, the electric field receiving member 16 may be made of BaTiO³ which does not include Pb. Thus, the electric field receiving member 16 is not evaporated into floating atoms easily due to the Joule heat, and the ionization by the emitted electrons is prevented. Therefore, the surface of the electric field receiving member 16 is effectively protected.

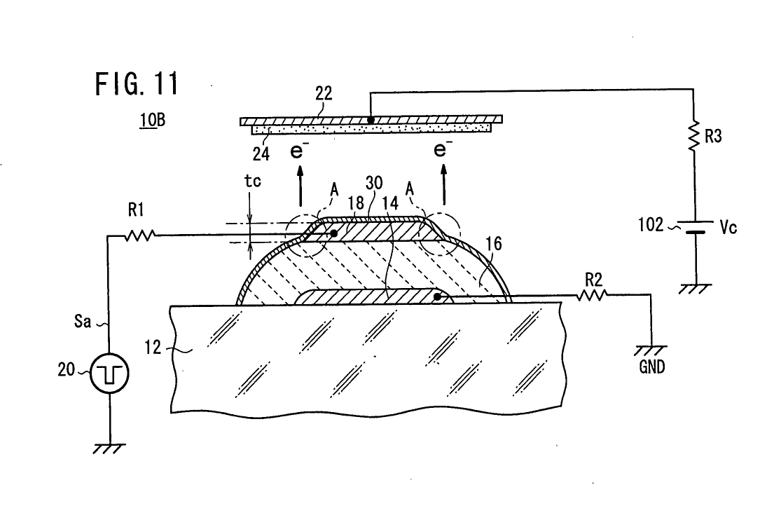

FIG. 11 is a view showing an electron emitter 10B according to a second embodiment of the present invention. The electron emitter 10B includes a protective film 30 formed on the electric field receiving member 16 to cover the cathode electrode 18. The protective film 30 formed on the surface of the electric field receiving member 18 prevent the electric field receiving member 16 from being damaged due to the electrons emitted from the cathode electrode 18 toward the electric field receiving member 16. Further, even if ionization occurs due to the electron emission, the protective film 30 reduces the damages of the cathode electrode 18 by the positive ions.

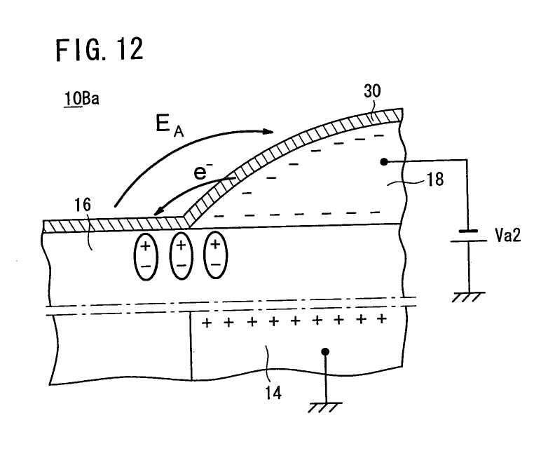

FIG. 12 is a view showing an electron emitter 10Ba of a first modification. The electron emitter 10Ba has a protective film 30 made of a conductor. The protective film 30 is likely to be eroded by the emitted electrons. The conductor should have a small sputtering yield (the number of target atoms or molecules per one incident ion). Preferably, the conductor has a sputtering yield of 2.0 or less at 600V in Ar⁺. Further, since the protective film 30 is evaporated due to the Joule heat, the ionization by the emitted electrons occurs easily. Therefore, the conductor should have a high evaporation temperature in vacuum. Preferably, the conductor has an evaporation pressure of 1.3×10⁻³ Pa at a temperature of 1800 K or higher in vacuum.

As described above, if the protective film 30 is made of a conductor, preferably, the conductor has a sputtering yield of 2.0 or less, and an evaporation temperature of 1800K or higher in vacuum.

The ordinary conductor such as Au has a high spattering yield 2.8 (AU), and not suitable for the protective film 30. Conductors having a high sputtering yield such as Mo (molybdenum) or C (carbon) are suitable. The sputtering yield of Mo is 0.9, and the sputtering yield of C is less than 0.2.

By selecting the material of the conductor, the protective film 30 is not broken easily. Therefore, the protect cover 30 is not evaporated into atoms due to the Joule heat. Thus, the electron emitter may have a longer service life.

Preferably, the protective film 30 has a thickness in the range of 1 nm to 20 nm. If the protective film 30 is too thin, the protective film 30 can not sufficiently protect the electric field receiving member 16. If the protective film 30 is too thick, the protective film 30 has a small electric resistance, and the voltage between the local cathode and the local anode is small. Therefore, sufficient electric field for emitting electrons may not be generated. Further, if the protective film 30 is too thick, the cathode electrode 18 can not emit electrons.

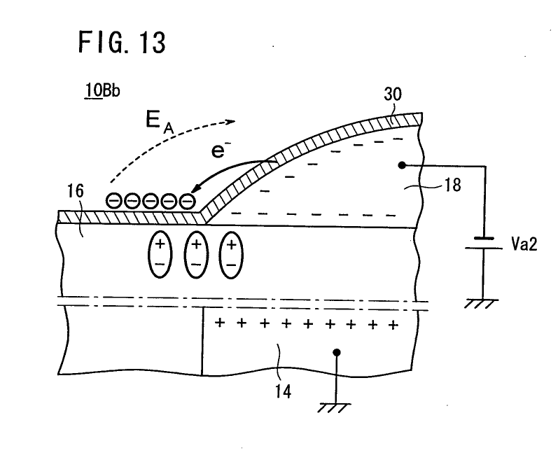

FIG. 13 is a view showing an electron emitter 10Bb of a second modification. In the electron emitter 10Bb, the protective film 30 is an insulator film such as SiO₂, or a metal oxide film such as MgO. Alternatively, the protective film 30 may be made of ceramics, a piezoelectric material, or an electrostrictive material.

When the electrons emitted from the cathode electrode 18 is attracted to the local anode of the electric field receiving member 16, the surface of the protective film 30 is charged negatively. Therefore, the positive polarity of the local anode is weakened, the electric field between the local anode and the local cathode is weakened, and the intensity E_{A} of the electric field between the local anode and the local cathode is reduced (the small intensity E_{A} of the electric field is indicated by the broken-line arrow in FIG. 13). Thus, the electron emission is stopped.

In the electron emitter 10A of the first embodiment, the electron emission is self-stopped when the surface of the electric field receiving member 16 is charged negatively. In the second modification, the electron emission is self-stopped when the surface of the protective film 30 is charged negatively.

When the protective film 30 is an insulator film or oxide film, the protective film 30 is not eroded by the electrons emitted from the cathode electrode 18. Therefore, the protective cover 30 is suitably used for protection.

In the electron emitters 10A and 10B according to the first and second embodiments (including the modifications), the collector electrode 22 is coated with a fluorescent layer 24 to for use as a pixel of a display. The displays of the electron emitters 10A and 10B offer the following advantages:
(1) The displays can be thinner (the panel thickness=several mm) than CRTs.
(2) Since the displays emit natural light from the fluorescent layer 24, they can provide a wide angle of view which is about 180° unlike LCDs (liquid crystal displays) and LEDs (light-emitting diodes).
(3) Since the displays employ a surface electron source, they produce less image distortions than CRTs.
(4) The displays can respond more quickly than LCDs, and can display moving images free of after image with a high-speed response on the order of μsec.
(5) The displays consume an electric power of about 100 W in terms of a 40-inch size, and hence is characterized by lower power consumption than CRTs, PDPs (plasma displays), LCDs, and LEDs.
(6) The displays have a wider operating temperature range (−40 to +85° C.) than PDPs and LCDs. LCDs have lower response speeds at lower temperatures.
(7) The displays can produce higher luminance than conventional FED displays as the fluorescent material can be excited by a large current output.
(8) The displays can be driven at a lower voltage than conventional FED displays because the drive voltage can be controlled by the polarization reversing characteristics and film thickness of the piezoelectric material.

Because of the above various advantages, the displays can be used in a variety of applications described below.

(1) Since the displays can produce higher luminance and consume lower electric power, they are optimum for use as 30- through 60-inch displays for home use (television and home theaters) and public use (waiting rooms, karaoke rooms, etc.).

(2) Inasmuch as the displays can produce higher luminance, can provide large screen sizes, can display full-color images, and can display high-definition images, they are optimum for use as horizontally or vertically long, specially shaped displays, displays in exhibitions, and message boards for information guides.

(3) Because the displays can provide a wider angle of view due to higher luminance and fluorescent excitation, and can be operated in a wider operating temperature range due to vacuum modularization thereof, they are optimum for use as displays on vehicles. Displays for use on vehicles need to have a horizontally long 8-inch size whose horizontal and vertical lengths have a ratio of 15:9 (pixel pitch=0.14 mm), an operating temperature in the range from −30 to +85° C., and a luminance level ranging from 500 to 600 cd/m² in an oblique direction.

Because of the above various advantages, the electron emitters can be used as a variety of light sources described below.

(1) Since the electron emitters can produce higher luminance and consume lower electric power, they are optimum for use as projector light sources which are required to have a luminance level of 200 lumens. In the case of carbon nanotube lamp, the luminance level is 104 cd/m² (160 lumens) when operated at an anode voltage 10 kV, an anode current 300 μA, on a fluorescent surface having a diameter of 27 mm. Therefore, the required luminance level for projector light sources is ten times higher than the luminance level of the carbon nanotube lamp. Therefore, it is difficult to use the carbon nanotube lamp as the projector light source.

(2) Because the electron emitters can easily provide a high-luminance two-dimensional array light source, can be operated in a wide temperature range, and have their light emission efficiency unchanged in outdoor environments, they are promising as an alternative to LEDs. For example, the electron emitters are optimum as an alternative to two-dimensional array LED modules for traffic signal devices. At 25° C. or higher, LEDs have an allowable current lowered and produce low luminance.

The electron emitter according to the present invention are not limited to the above embodiments, but may be embodied in various arrangement without departing from the scope of the present invention.

1. An electron emitter comprising:
an anode electrode formed on a substrate;
an electric field receiving member made of a dielectric material, said electric field receiving member being formed on said substrate to cover said anode electrode; and
a cathode electrode to which a drive signal is supplied, said cathode electrode being formed on said electric field receiving member.

2. An electron emitter according to claim 1, wherein said electric field receiving member is made of a piezoelectric material, an anti-ferroelectric material, or an electrostrictive material.

3. An electron emitter according to claim 1, wherein polarization reversal occurs in an electric field E represented by E=V/d, where d is a thickness of said electric field receiving member between said cathode electrode and said anode electrode, and V is a voltage applied between said cathode electrode and said anode electrode.

4. An electron emitter according to claim 3, wherein the thickness d is determined so that the voltage V applied between said cathode electrode and said anode electrode has an absolute value of less than 100V.

5. An electron emitter according to claim 1, wherein a collector electrode is provided above said cathode electrode, and said collector electrode is coated with a fluorescent layer.

6. An electron emitter according to claim 1, wherein at least said cathode electrode has a ring shape.

7. An electron emitter according to claim 1, wherein at least said cathode electrode has a comb teeth shape.

8. An electron emitter according to claim 1, wherein said cathode electrode has a thickness of 100 nm or less.

9. An electron emitter according to claim 1, wherein a protective film is formed on said electric field receiving member to cover said cathode electrode.

10. An electron emitter according to claim 9, wherein said protective film has a thickness in the range of 1 nm to 20 nm.

11. An electron emitter according to claim 9, wherein said protective film is made of a conductor.

12. An electron emitter according to claim 11, wherein said conductor has a sputtering yield of 2.0 or less at 600 V in Ar⁺ and an evaporation pressure of 1.3×10⁻³ Pa at a temperature of 1800 K or higher.

13. An electron emitter according to claim 9, wherein said protective film is an insulator film.

14. An electron emitter according to claim 9, wherein said protective film is a metal oxide film.

15. An electron emitter according to claim 9, wherein said protective film is made of ceramics, a piezoelectric material, or an electrostrictive material.

16. An electron emitter according to claim 1, wherein the change of the voltage applied between said cathode electrode and said anode electrode at the time of electron emission is 20V or less.
